(19) United States
(12) Patent Application Publication
(10) Pub. No.: US 2008/0270782 A1
(43) Pub. Date: Oct. 30, 2008

(54) BOOT PROCESS

(75) Inventors: Nicholas BONE, Thatcham (GB); Caroline Jessica BELROSE, Marlborough (GB); Timothy James WRIGHT, Reading (GB)

Correspondence Address: WORKMAN NYDEGGER, 60 EAST SOUTH TEMPLE, 1000 EAGLE GATE TOWER, SALT LAKE CITY, UT, 84111, US

(73) Assignee: VODAFONE GROUP PLC, Newbury (GB)

(21) Appl. No.: 11/876,675

(22) Filed: Oct. 22, 2007

(30) Foreign Application Priority Data
Oct. 20, 2006 (GB) 0620928.2

(51) Int. Cl. G06F 9/00

(52) U.S. Cl. 713/2

(57) ABSTRACT

When a secure boot operation fails, the operation of a mobile telecommunications terminal can be severely impacted. In order to lower the impact on the user, one example embodiment of the invention relates to a method for automatically implementing a “safe boot” mode, whereby code can be accessed solely for the purpose of handling failed operations and if necessary providing limited services from the failing terminal.

### CROSS-REFERENCE TO RELATED APPLICATION

This application claims priority to UK Patent Application No. GB0620928.2, filed on Oct. 20, 2006, which is incorporated herein by reference in its entirety.

### BACKGROUND

1. Field of the Invention

The present invention relates to a process for ensuring the integrity of terminal boot operations.

2. Description of the Related Art

In order to protect the integrity of core software on a mobile telecommunications terminal, such as the Operating System (OS), a secure boot process can be implemented in which the integrity of certain core code is verified before the code is loaded in the boot process. If it is likely that this core code may change over its lifetime, such as code that may require updates, for example, then a flexible secure boot process can be implemented where core code, along with the measurements to which it is compared at boot time, may be updated by authorized parties.

However it is possible that the secure boot process may fail due to corruption of the core code or failure of code updates, for example. In most instances when the secure boot process fails, the terminal will shut down since it may not be adequately trusted to do anything else.

This makes it impossible to recover from secure boot failures over the air, and does not provide for a good user experience since the user would have to take their terminal to a local operator's shop for recovery.

### SUMMARY OF EXAMPLE EMBODIMENTS

It is therefore an object of the invention to obviate or at least mitigate the aforementioned problems.

In accordance with one aspect of the present invention, there is provided a method for booting a mobile device having safe boot code and normal boot code, the method including: checking the value of a safe boot flag, where the value of the flag indicates that safe boot is required, performing a safe boot operation; where the value of the flag indicates that no safe boot is required, attempting a normal boot operation; and where the normal boot operation fails, setting the safe boot flag to indicate the need for a safe boot operation, thereby causing the next boot to be a safe boot.

The normal boot may be a secure boot and the safe boot too may be a secure boot. Furthermore, the secure boot may use a secure boot mechanism that includes RIMs.

In one variant, the safe boot may use a protected subset of the code used for the normal boot.

In accordance with a further aspect of the invention, there is provided a mobile device having a safe boot functionality, the device including: a flag memory for storing the value of a safe boot flag, where the value of the flag indicates whether safe boot is required; a normal boot memory for storing normal boot code; a safe boot memory for storing safe boot code; and a processor for checking the value of the flag and for performing a safe boot operation; wherein, in operation, the processor executes a normal boot operation where the value of the flag indicates that no safe boot is required, and sets the safe boot flag to indicate the need for a safe boot operation where the normal boot operation fails, thereby causing the next boot to be a safe boot.

In another variant, the safe boot code may be stored in memory separate from the memory used to store the normal boot code. In particular, the separate memory may be provided on a removable memory card. Alternatively, the separate memory may be provided on a SIM card.

### BRIEF DESCRIPTION OF THE DRAWINGS

Aspects of example embodiments of the invention will become apparent from the following description of example embodiments given in conjunction with the accompanying drawings, in which:

FIG. 1 discloses an example mobile telecommunications terminal; and

FIG. 2 discloses an example method for booting a mobile device having safe boot code and normal boot code.

### DETAILED DESCRIPTION OF EXAMPLE EMBODIMENTS

Safe boot processes are known in the field of computer hardware. Conventionally, however, the decision to enter safe boot is externally triggered. This is particularly inappropriate in the case of mobile terminals since the expectation of the user is to have continual service.

In one example embodiment of the invention, entry to a safe boot is predicated on a device flag set during an earlier secure boot operation that failed, and thus requires no external triggering.

Reference will now be made to the Figures in order to disclose aspects of example embodiments of the invention.

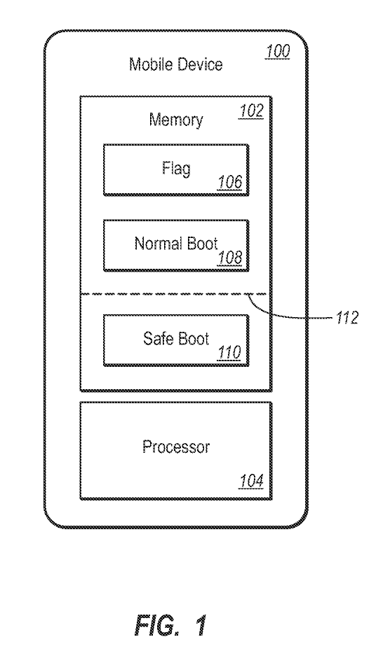

With reference now to FIG. 1, an example mobile telecommunications terminal 100 is provisioned with a secure boot process. The example terminal 100 may be, but is not limited to, a mobile phone or other mobile telecommunication device. As disclosed in FIG. 1, the example terminal 100 generally includes a memory 102 and a processor 104. The memory 102 can be, but is not limited to, a flash memory. The memory 102 generally includes a portion 106 configured to store a safe boot flag, a portion 108 configured to store normal boot code, and a portion 10 configured to store safe boot code. Although the memory 102 is illustrated as a single memory divided into several portion, it is contemplated that the memory 102 can instead be comprised of multiple physically separate internal and/or external memory, as indicated by the dotted line 112, such as a physically separate removable memory card or a SIM card that is inserted into the terminal 100.

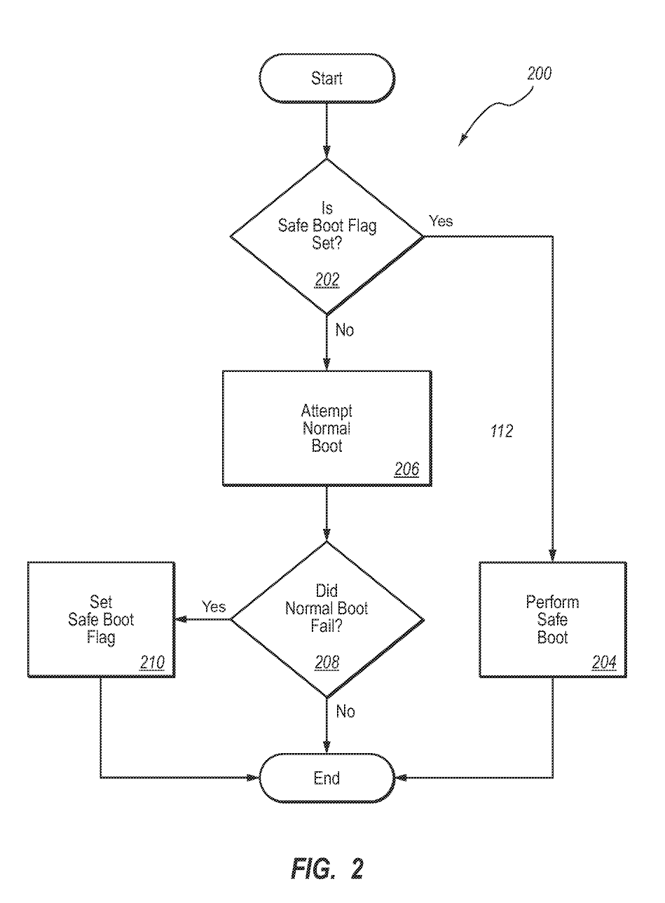

With continuing reference to FIG. 1, and with reference now also to FIG. 2, an example method 200 for booting a mobile device having safe boot code and normal boot code is disclosed. The example method 200 will be discussed in connection with the example terminal 100, although it is understood that the example method 200 is not limited to being employed in connection with the example terminal 100, and can instead be employed in connection with other mobile devices having safe boot code and normal boot code.

At 202, prior to the booting of the terminal 100, the terminal 100 checks the secure boot success flag stored at 106 to determine whether the flag indicates that the previous secure boot failed. If the flag is set, then the method 200 proceeds to 204, where the terminal 100 initiates a “safe” debug boot process which boots into a “safe” debug mode that offers limited functionality to enable the terminal 100 to be recovered and from which diagnostic information may be retrievable. The safe debug mode, in one variant of the embodiment, is the implementation of a subset of the normal boot code and, in another variant, the implementation of a completely different debug boot code. In one example embodiment, the terminal 100 safeguards the safe debug boot code stored at 110 of the memory 102 by only using the safe debug boot code during the safe debug boot process.

Furthermore, in the variant of the embodiment using completely different debug boot code, the debug boot code may be stored separately from the normal boot code, for example, in a separate part of the memory 102 of the terminal 100 or on a memory card or SIM card inserted in the terminal 100. Where a subset of the normal boot code is used, this too is stored separately from the rest of normal boot code, for example, in a separate part of the flash memory of the terminal 100 or on a memory card or SIM card inserted in the terminal 100.

In a further variant of the embodiment, the Trusted Computing Group (TCG) secure boot mechanism, or an equivalent secure boot mechanism, may be deployed, and the debug boot code will be integrity protected using a separate set of Reference Integrity Metrics (RIM) certificates, which are not used except for debug boots.

A safe debug boot allows the terminal 100 to enter a trusted state after the failure of a normal secure boot process, from which it would be possible to perform over the air (OTA) diagnostic and recovery operations. Alternatively, or additionally, the boot process responds to integrity failures during run-time by setting the safe boot flag before the terminal 100 is next booted, so that the next boot will be an instance of a safe debug boot. This would be done where it is anticipated that a normal boot would fail, thereby avoiding the need for the terminal 100 to experience a failed normal boot and a subsequent reboot.

Depending on the severity of the failures, the user may even be provided with limited functionality after the safe debug boot. This would greatly improve the user experience since it avoids the user having to take the terminal 100 into a store. It would also make recovery procedures more efficient since they may be done over the air.

If the terminal 100 determines at 102 that the flag stored at is not set at 102, then the terminal 100 proceeds to 206 where the terminal 100 attempts a normal boot process. If it is determined at 208 that the normal secure boot process failed, such as where some piece of code fails verification, for example, then the normal boot process terminates, diagnostic information is written to a secure boot diagnostic file, and a secure boot flag is set at 210 to indicate that the secure boot process failed.

What is claimed is:

1. A method for booting a mobile device having safe boot code and normal boot code, the method including:
checking the value of a safe boot flag,
performing a safe boot operation where the value of the flag indicates that safe boot is required,
attempting a normal boot operation where the value of the flag indicates that no safe boot is required; and
setting the safe boot flag to indicate the need for a safe boot operation where the normal boot operation fails, thereby causing the next boot to be a safe boot.

2. A method as claimed in claim 1, wherein the normal boot operation is a secure boot operation.

3. A method as claimed in claim 1, wherein the safe boot operation is a secure boot operation.

4. A method as claimed in claim 2, wherein the secure boot operation uses a secure boot mechanism that includes RIMs.

5. A method as claimed in claim 3, wherein the secure boot operation uses a secure boot mechanism that includes RIMs.

6. A method as claimed in claim 1, wherein the safe boot operation uses a protected subset of the code used for normal boot operation.

7. A method as claimed in claim 1, wherein the safe boot flag is set after a run-time failure, thereby causing the next boot to be a safe boot.

8. A mobile device having a safe boot functionality, the device including:
a flag memory for storing the value of a safe boot flag, where the value of the flag indicates whether a safe boot is required;
a normal boot memory for storing normal boot code;
a safe boot memory for storing safe boot code; and
a processor for checking the value of the flag and for performing a safe boot operation;
wherein, in operation, the processor is configured to execute a normal boot operation where the value of the flag indicates that no safe boot is required, and is configured to set the safe boot flag to indicate the need for a safe boot operation where the normal boot operation fails, thereby causing the next boot to be a safe boot.

9. A device as claimed in claim 7, wherein the normal boot memory and safe boot memory are provided in a common memory.

10. A device as claimed in claim 7, wherein the normal boot memory is physically separate from the safe boot memory.

11. A device as claimed in claim 9, wherein the safe boot memory is provided on a removable memory card.

12. A device as claimed in claim 10, wherein the safe boot memory is provided on a SIM card.
